(19) United States
(12) Patent Application Publication
(10) Pub. No.: US 2009/0244790 A1
(43) Pub. Date: Oct. 1, 2009

(54) MAGNETORESISTIVE ELEMENT AND LAYERED OBJECT

(75) Inventors: Takahiro Ibusuki, Kawasaki (JP); Masashige Sato, Kawasaki (JP); Shinjiro Umehara, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/409,330

(22) Filed: Mar. 23, 2009

(30) Foreign Application Priority Data
Mar. 28, 2008 (JP) 2008-088189
Dec. 19, 2008 (JP) 2008-323983

(51) Int. Cl. G11B 5/127

(52) U.S. Cl. 360/324.1; G9B/5.04

(57) ABSTRACT

An magnetoresistive element includes: an underlayer made of a nitride; a pinning layer made of an antiferromagnetic layer overlaid on the underlayer, the pinning layer having the close-packed surface in the (111) surface of crystal, the pinning layer setting the (002) surface of crystal in parallel with the surface of the underlayer; a reference layer overlaid on the pinning layer, the reference layer having the magnetization fixed in a predetermined direction based on the exchange coupling with the pinning layer; a nonmagnetic layer overlaid on the reference layer, the nonmagnetic layer made of a nonmagnetic material; and a free layer overlaid on the nonmagnetic layer, the free layer made of a ferromagnetic material, the free layer enabling a change in the direction of the magnetization under the influence of an external magnetic field.

### CROSS-REFERENCE TO RELATED APPLICATION

This application is based upon and claims the benefit of priority from the prior Japanese Patent Application No. 2008-323983 filed on Dec. 19, 2008 and No. 2008-088189 filed on Mar. 28, 2008, the entire contents of which are incorporated herein by reference.

### FIELD

The embodiments discussed herein are related to a magnetoresistive element. The embodiments are related to a layered object including an antiferromagnetic layer having a close-packed surface in the (111) surface.

### BACKGROUND

The tunnel-junction magnetoresistive (TMR) element is well known. The tunnel-junction magnetoresistive element includes a reference layer having the magnetization fixed in a predetermined direction irrespective of the influence of the external magnetic field, and a free layer enabling changes in the direction of magnetization under the influence of the external magnetic field. A nonmagnetic layer made of a nonmagnetic material is interposed between the reference layer and the free layer. The electrical resistance changes in accordance with the relative angle between the direction of magnetization in the reference layer and the direction of magnetization in the free layer. An antiferromagnetic layer is utilized to fix the magnetization of the reference layer in a predetermined direction. The antiferromagnetic layer is overlaid on an underlayer. The (111) surface of the crystal are aligned in parallel with the surface of the underlayer in the antiferromagnetic layer.

The utilization of a Heusler alloy is proposed in the field of the tunnel-junction magnetoresistive elements. The reference layer may be made of a Heusler alloy, for example. The Heusler alloy realizes a remarkable difference in the density of states between upspin and downspin at the Fermi surface. Electro conductance of minority and majority spin is metallic and semi conductance, respectively. Therefore, TMR elements with the Heusler alloy are expected to realize a higher magnetoresistance (MR) ratio. In this case, the Heusler alloy is preferably made to establish a crystal having the (002) surface oriented in parallel with the surface of the underlayer. The establishment of such (002) surface requires the minimization of the thickness. The Heusler alloy, which exhibits a high polarizability at the Fermi surface, includes CO₂MnAl, CO₂MnSi, CO₂FeAl, CO₂FeSi, CO₂FeAl_{0.5}Si_{0.5}, and the like.

### SUMMARY

According to an aspect of the invention, an magnetoresistive element includes: an underlayer made of a nitride; a pinning layer made of an antiferromagnetic layer overlaid on the underlayer, the pinning layer having the close-packed surface in the (111) surface of crystal, the pinning layer orienting the (002) surface of crystal in parallel with the surface of the underlayer; a reference layer overlaid on the pinning layer, the reference layer having the magnetization fixed in a predetermined direction based on the exchange coupling with the pinning layer; a nonmagnetic layer overlaid on the reference layer, the nonmagnetic layer made of a nonmagnetic material; and a free layer overlaid on the nonmagnetic layer, the free layer made of a ferromagnetic material, the free layer enabling a change in the direction of the magnetization under the influence of an external magnetic field.

There may be provided a specific layered object to realize the magnetoresistive element. The layered object may include: an underlayer made of a nitride; and an antiferromagnetic layer overlaid on the underlayer, the antiferromagnetic layer having the close-packed surface in the (111) surface of crystal, the antiferromagnetic layer orienting the (002) surface of crystal in parallel with the surface of the underlayer.

The object and advantages of the embodiment will be realized and attained by means of the elements and combinations particularly pointed out in the appended claims. It is to be understood that both the foregoing general description and the following detailed description are exemplary and explanatory and are not restrictive of the embodiment, as claimed.

### BRIEF DESCRIPTION OF THE DRAWINGS

FIG. 1 is a plan view schematically illustrating the inner structure of a hard disk drive as a specific example of a storage device;

FIG. 2 is an enlarged perspective view schematically illustrating a flying head slider according to a specific example;

FIG. 3 is a front view schematically illustrating an electromagnetic transducer observed at a bottom surface of the flying head slider;

FIG. 4 is a sectional view taken along the line 4-4 in FIG. 3;

FIG. 5 is an enlarged front view schematically illustrating a tunnel-junction magnetoresistive film according to a first embodiment;

FIG. 6 is a view schematically illustrating a process of making the tunnel-junction magnetoresistive film;

FIG. 7 is a graph specifying the respective oriented surfaces of IrMn layers formed on a NiFe layer and a NiFeN layer;

FIG. 8 is a graph specifying the oriented surface of a CO₂MnSi layer formed on an IrMn layer whose oriented surface is the (002) surface;

FIG. 9 is a graph specifying the oriented surface of an MgO layer formed on a CO₂MnSi layer on an IrMn layer whose oriented surface is the (002) surface;

FIG. 10 is a graph specifying the respective oriented surfaces of IrMn layers formed on a Cu layer and a CuN layer;

FIG. 11 is a graph specifying the respective oriented surfaces of IrMn layers formed on a Ti layer and a TiN layer;

FIG. 12 is a graph specifying the respective oriented surfaces of IrMn layers formed on a NiCr layer and a NiCrN layer;

FIG. 13 is a graph specifying the respective oriented surfaces of IrMn layers formed on a Cr layer and a CrN layer;

FIG. 14 is a graph specifying the respective oriented surfaces of IrMn layers formed on a Ru layer, a RuN layer and a RuO layer;

FIG. 15 is a graph specifying the oriented surface of a Cu layer or a CuN layer depending on the amount of added nitrogen;

FIG. 16 is a graph specifying the oriented surface of a NiFeN layer depending on the amount of the added nitrogen;

FIG. 17 is a graph specifying the oriented surface of a CO₂FeAl_{0.5}Si_{0.5} formed on an IrMn layer whose oriented surface is the (002) surface;

FIG. 18 is a graph depicting the magnetoresistance ratio (MR ratio) of a tunnel-junction film including CO₂FeAl_{0.5}Si_{0.5} layers and the MR ratio of a tunnel-junction film including CoFe layers;

FIG. 19 is an enlarged front view schematically illustrating a tunnel-junction magnetoresistive film according to a second embodiment; and

FIG. 20 is a circuit diagram schematically illustrating a magnetic random access memory (MRAM).

### DESCRIPTION OF EMBODIMENTS

Embodiments of the invention will be explained below with reference to the accompanying drawings.

FIG. 1 schematically illustrates the inner structure of a hard disk drive, HDD, 11 as an example of a storage medium drive or storage device. The hard disk drive 11 includes a box-shaped enclosure 12. The enclosure 12 includes an enclosure cover, not depicted, and a boxed-shaped enclosure base 13 defining an inner space of a flat parallelepiped, for example. The enclosure base 13 may be made of a metallic material such as aluminum, for example. Molding process may be employed to form the enclosure base 13. The enclosure cover is coupled to the enclosure base 13. The enclosure cover serves to close the opening of the inner space in the enclosure base 13. Pressing process may be employed to form the enclosure cover out of a plate material, for example.

At least one magnetic recording disk 14 as a storage medium is located in the inner space of the enclosure base 13. The magnetic recording disk or disks 14 are mounted on the driving shaft of a spindle motor 15. The spindle motor 15 drives the magnetic recording disk or disks 14 at a higher revolution speed such as 3,600 rpm, 4,200 rpm, 5,400 rpm, 7,200 rpm, 10,000 rpm, 15,000 rpm, or the like. Here, a so-called perpendicular magnetic recording disk is employed as the magnetic recording disk or disks 14, for example. Specifically, the axis of easy magnetization is set in the direction perpendicular to the surface of the magnetic recording disk 14 in a magnetic layer for recordation on the magnetic recording disk 14.

A carriage 16 is also located in the inner space of the enclosure base 13. The carriage 16 includes a carriage block 17. The carriage block 17 is supported on a vertical support shaft 18 for relative rotation. Carriage arms 19 are defined in the carriage block 17. The carriage arms 19 extend in a horizontal direction from the vertical support shaft 18. The carriage block 17 may be made of aluminum, for example. Extrusion process may be employed to form the carriage block 17, for example.

A head suspension 21 is attached to the front or tip end of the individual carriage arm 19. The head suspension 21 extends forward from the carriage arm 19. A flexure is attached to the head suspension 21. The flexure defines a so-called gimbal at the front or tip end of the head suspension 21. A magnetic head slider, namely a flying head slider 22, is supported on the gimbal. The gimbal allows the flying head slider 22 to change its attitude relative to the head suspension 21. A magnetic head, namely an electromagnetic transducer is mounted on the flying head slider 22.

When the magnetic recording disk 14 rotates, the flying head slider 22 is allowed to receive airflow generated along the rotating magnetic recording disk 14. The airflow serves to generate a positive pressure or lift as well as a negative pressure on the flying head slider 22. The lift of the flying head slider 22 is balanced with the urging force of the head suspension 21 and the negative pressure so that the flying head slider 22 keeps flying above the surface of the magnetic recording disk 14 at a higher stability during the rotation of the magnetic recording disk 14.

A power source such as a voice coil motor, VCM, 23 is coupled to the carriage block 17. The voice coil motor 23 serves to drive the carriage block 17 around the vertical support shaft 18. The rotation of the carriage block 17 allows the carriage arms 19 and the head suspensions 21 to swing. When the individual carriage arm 19 swings around the vertical support shaft 18 during the flight of the flying head slider 22, the flying head slider 22 is allowed to move in the radial direction of the magnetic recording disk 14. The electromagnetic transducer on the flying head slider 22 is thus allowed to cross the data zone defined between the innermost and outermost recording tracks. The electromagnetic transducer on the flying head slider 22 is positioned right above a target recording track on the magnetic recording disk 14.

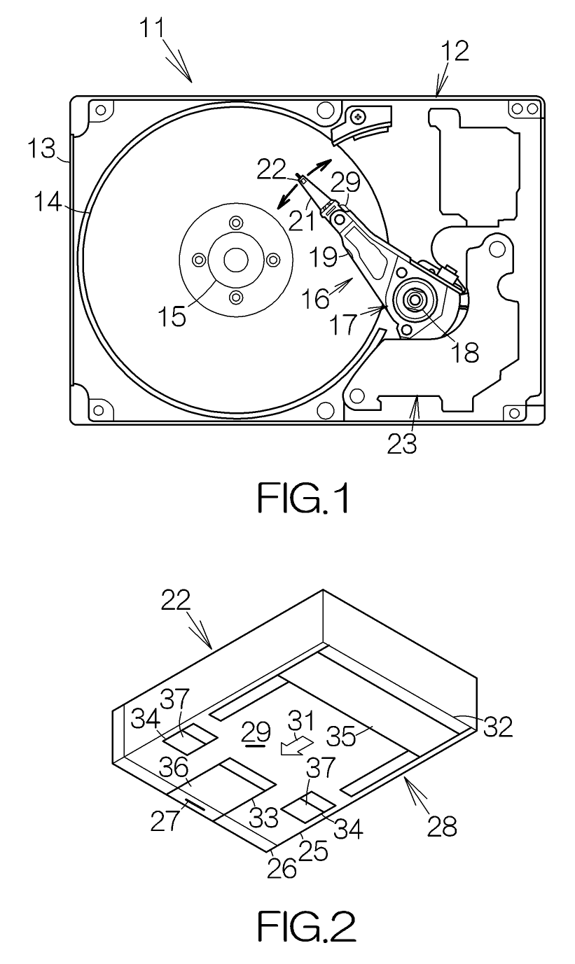

FIG. 2 illustrates a specific example of the flying head slider 22. The flying head slider 22 includes a base material or slider body 25 in the form of a flat parallelepiped, for example. An insulating nonmagnetic film, namely a head protection film 26, is overlaid on the outflow or trailing end surface of the slider body 25. An electromagnetic transducer 27 is embedded in the head protection film 26. The electromagnetic transducer 27 will be described later in detail.

The slider body 25 may be made of a hard nonmagnetic material such as Al₂O₃—TiC. The head protection film 26 is made of an insulating, nonmagnetic, relatively soft material such as Al₂O₃ (alumina). A bottom surface 28 as a medium-opposed surface is defined over the slider body 25 to face the magnetic recording disk 14 at a distance. A flat base surface 29 as a reference surface is defined on the bottom surface 28. When the magnetic recording disk 14 rotates, airflow 31 flows along the bottom surface 28 from the inflow or leading end toward the outflow or trailing end of the slider body 25.

A front rail 32 is formed on the bottom surface 28 of the slider body 25. The front rail 32 stands upright from the base surface 29 near the inflow end of the slider body 25. The front rail 32 extends along the inflow end of the base surface 29 in the lateral direction of the slider body 25. A rear center rail 33 is likewise formed on the bottom surface 28 of the slider body 25. The rear center rail 33 stands upright from the base surface 29 near the outflow end of the slider body 25. The rear center rail 33 is located at the intermediate position in the lateral direction of the slider body 25. The rear center rail 33 extends to reach the head protection film 26. A pair of rear side rails 34, 34 is likewise formed on the bottom surface 28 of the slider body 25. The rear side rails 34, 34 stand upright from the base surface 29 of the bottom surface 28 near the outflow end of the slider body 25. The rear side rails 34, 34 are located along the sides of the slider body 25, respectively. The rear center rail 33 is located in a space between the rear side rails 34, 34.

Air bearing surfaces 35, 36, 37 are defined on the top surfaces of the front rail 32, the rear center rail 33 and the rear side rails 34, respectively. Steps are formed to connect the inflow ends of the air bearing surfaces 35, 36, 37 to the top surfaces of the front rail 32, the rear center rail 33 and the rear side rails 34, respectively. When the bottom surface 28 of the flying head slider 22 receives the airflow 31, the steps serve to generate a larger positive pressure or lift at the air bearing surfaces 35, 36, 37, respectively. Moreover, a larger negative pressure is generated behind the front rail 32 or at a position downstream of the front rail 32. The negative pressure is balanced with the lift so as to stably establish the flying attitude of the flying head slider 22. It should be noted that the flying head slider 22 can take any shape or form different from the described one.

The electromagnetic transducer 27 is embedded in the rear center rail 33 at a position downstream of the air bearing surface 36. The electromagnetic transducer 27 includes a read element and a write element. A tunnel-junction magnetoresistive (TMR) element is employed as the read element. The TMR element is allowed to induce variation in the electric resistance of the tunnel-junction film in response to the inversion of polarization in the applied magnetic field leaked from the magnetic recording disk 14. This variation in the electric resistance is utilized to discriminate binary data recorded on the magnetic recording disk 14. A so-called single-pole head is employed as the write element. The single-pole head generates a magnetic field with the assistance of a thin film coil pattern. The generated magnetic field is utilized to record binary data into the magnetic recording disk 14. The electromagnetic transducer 27 allows the read gap of the read element and the write gap of the write element to get exposed at the surface of the head protection film 26. A hard protection film may be formed on the surface of the head protection film 26 at a position downstream of the air bearing surface 36. Such a protection film covers over the write gap and the read gap exposed at the surface of the head protection film 26. The protection film may be made of a diamond like carbon (DLC) film, for example.

As depicted in FIG. 3, the read element 42 includes a tunnel-junction magnetoresistive film 45 interposed between a pair of electrically-conductive layers, namely a lower electrode layer 43 and an upper electrode layer 44. The lower electrode layer 43 and the upper electrode layer 44 may be made of a material having a high magnetic permeability such as FeN (iron nitride) or NiFe (nickel iron). The thicknesses of the lower electrode layer 43 and the upper electrode layer 44 are set in a range from 2.0 μm to 3.0 μm, for example. The lower electrode layer 43 and the upper electrode layer 44 serve as a lower shielding layer and an upper shielding layer, respectively. Space between the lower and upper electrode layers 43, 44 serves to determine a linear resolution of magnetic recordation on the magnetic recording disk 14 along the recording track.

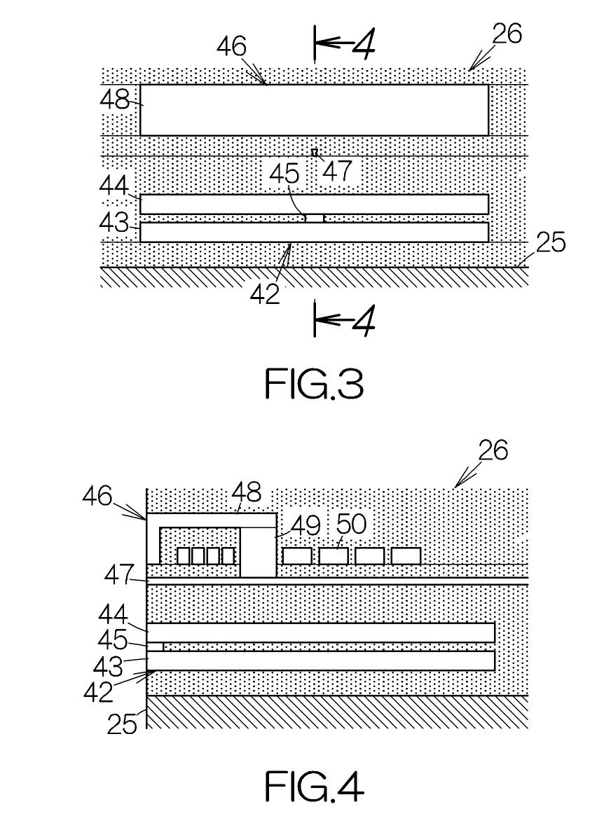

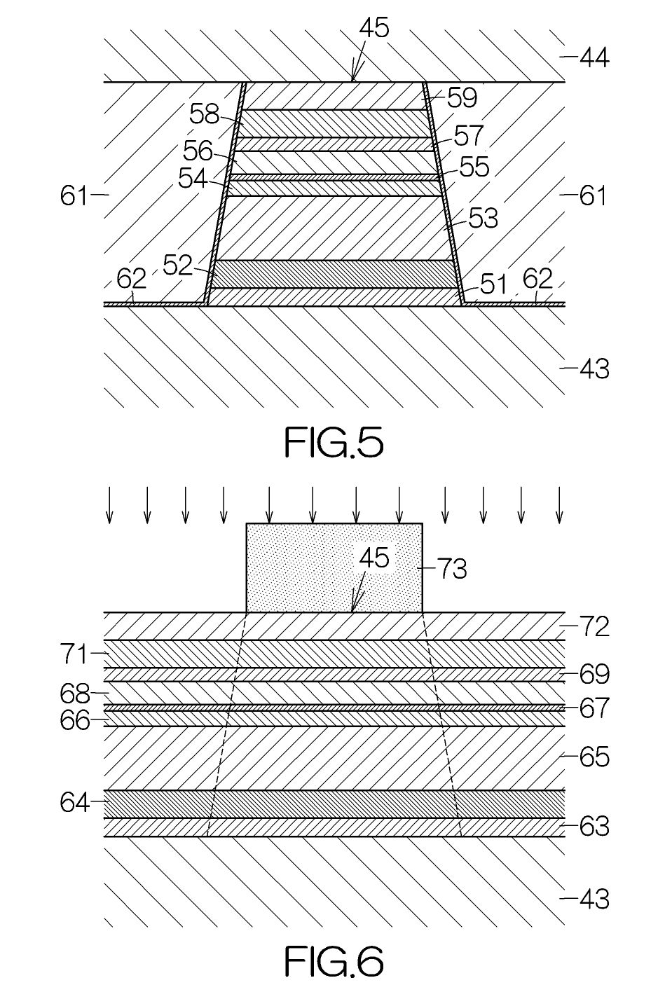

The write element 46, namely the single-pole head, includes a main magnetic pole 47 and an auxiliary magnetic pole 48, exposed at the surface of the rear center rail 33. The main magnetic pole 47 and the auxiliary magnetic pole 48 may be made of a magnetic material such as FeN or NiFe. Referring also to FIG. 4, a magnetic connecting piece 49 connects the rear end of the auxiliary magnetic pole 48 to the main magnetic pole 47. A magnetic coil, namely a thin film coil pattern 50, is formed in a swirly pattern around the magnetic connecting piece 49. The main magnetic pole 47 works as a magnetic core which is penetrating through the center of the thin film coil pattern 50 in combination with the auxiliary magnetic pole 48 and the magnetic connecting piece 49.

FIG. 5 schematically illustrates the tunnel-junction magnetoresistive film 45 according to a first embodiment. The tunnel-junction magnetoresistive film 45 has a so-called bottom type layered structure. The tunnel-junction magnetoresistive film 45 includes an auxiliary underlayer 51 extending over the lower electrode layer 43, as depicted in FIG. 5. The auxiliary underlayer 51 is made of Ta (tantalum), for example. The auxiliary underlayer 51 has an amorphous structure. The thickness of the auxiliary underlayer 51 is set at 2.0 nm, for example.

An underlayer 52 is overlaid on the surface of the auxiliary underlayer 51. The underlayer 52 is made of a nitride. Here, the underlayer 52 is made of NiFeN (nickel iron nitride). The thickness of the underlayer 52 is set at 3.0 nm, for example.

A pinning layer 53 is overlaid on the surface of the underlayer 52. The pinning layer 53 is an antiferromagnetic layer. Here, the pinning layer 53 is made of an IrMn (Iridium Manganese) alloy. The pinning layer 53 has an fcc (face-centered cubic) structure. The fcc structure includes a closed-packed surface corresponding to the (111) surface of crystal. The nitride of the underlayer 52 greatly contributes to establishment of a preferential orientation of the (002) surface in the pinning layer 53 in parallel with the surface of the underlayer 52 as described later in detail. The thickness of the pinning layer 53 is set at 7.0 nm, for example.

A pinned layer 54 is overlaid on the surface of the pinning layer 53. The pinned layer 54 is a ferromagnetic layer. Here, the pinned layer 54 is made of a CoFe (cobalt iron) alloy. The thickness of the pinned layer 54 is set at 1.7 nm, for example. Exchange coupling is established between the pinned layer 54 and the pinning layer 53. The exchange coupling serves to fix the magnetization of the pinned layer 54 in a predetermined direction. It may be ensured that the thickness of the pinning layer 53 made of IrMn is set equal to or larger than 4.0 nm, for example, to establish the exchange coupling.

A nonmagnetic interlayer 55 is overlaid on the surface of the pinned layer 54. The nonmagnetic interlayer 55 is made of a nonmagnetic material. Here, the nonmagnetic interlayer 55 is made of Ru (ruthenium). The thickness of the nonmagnetic interlayer 55 is set at 0.68 nm, for example.

A reference layer 56 is overlaid on the surface of the nonmagnetic interlayer 55. The reference layer 56 is made of a Heusler alloy. Here, the reference layer 56 is made of a CO₂MnSi (cobalt manganese silicon) alloy. The thickness of the reference layer 56 is set at 2.5 nm, for example. The Heusler alloy has a predetermined crystalline structure such as the L2₁ structure, the B2 structure, and the like, for example. The (002) surface is preferentially oriented in the reference layer 56 in parallel with the surface of the nonmagnetic interlayer 55. The reference layer 56 in combination with the pinned layer 54 and the nonmagnetic interlayer 55 establishes a synthetic ferri structure. Exchange coupling is thus induced between the pinned layer 54 and the reference layer 56. The exchange coupling produces an antiparallel relationship between the magnetization of the reference layer 56 and the magnetization of the pinned layer 54. It should be noted that the reference layer 56 may directly be overlaid on the surface of the pinning layer 53. In this case, exchange coupling is induced between the reference layer 56 and the pinning layer 53.

A tunnel barrier layer 57 is overlaid on the surface of the reference layer 56. The tunnel barrier layer 57 is made of an electrically-insulating material. Here, the tunnel barrier 57 is made of MgO (magnesium oxide). The thickness of the tunnel barrier layer 57 is set in a range from 1.0 nm to 1.5 nm, for example.

A free layer 58 is overlaid on the surface of the tunnel barrier layer 57. The free layer 58 is a ferromagnetic layer. Here, the free layer 58 is a CoFeB (cobalt iron boron) layer. The thickness of the free layer 58 is set at 3.0 nm, for example. The free layer 58 enables a change in the direction of the magnetization under the influence of an external magnetic field.

A capping layer 59 is overlaid on the surface of the free layer 58. The capping layer 59 is made of a nonmagnetic metallic material, for example. Here, the capping layer 59 is made of Ta (tantalum). The thickness of the capping layer 59 is set equal to or larger than 3.0 nm, for example. The capping layer 59 can be a Ru (ruthenium) layer or a Ti (titanium) layer. Alternatively, the capping layer 59 may be a layered body including a Ta layer and a Ru layer.

The aforementioned upper electrode layer 44 is overlaid on the capping layer 59. A pair of magnetic domain controlling films 61 is located between the upper electrode layer 44 and the lower electrode layer 43. The tunnel-junction magnetoresistive film 45 is interposed between the magnetic domain controlling films 61 along the bottom surface 28. The magnetic domain controlling films 61 may be made of a hard magnetic material, for example. Here, the magnetic domain controlling films 61 are made of CoCrPt (cobalt chromium platinum alloy), for example. The magnetic domain controlling films 61 are magnetized in a predetermined direction. The magnetization of the magnetic domain controlling films 61 generates a magnetic field across the free layer 58 along the bottom surface 28. The magnetic domains thus have the magnetization in a specific single direction in the free layer 58.

An insulating film 62 is formed between the tunnel-junction magnetoresistive film 45 and each of the magnetic domain controlling films 61. The insulating film 62 is made of Al₂O₃, for example. The thickness of the insulating film 62 is set in a range from 3.0 nm to 10.0 nm, for example. The insulating film 62 serves to insulate the magnetic domain controlling films 61 from the tunnel-junction magnetoresistive film 45. The insulating film 62 is likewise formed between the lower electrode layer 43 and each of the magnetic domain controlling films 61. The insulating film 62 is made of Al₂O₃, for example. The thickness of the insulating film 62 is set in a range from 3.0 nm to 10.0 nm, for example. The insulating film 62 serves to insulate the magnetic domain controlling films 61 from the lower electrode layer 43. Consequently, even if the magnetic domain controlling films 61 have electrical conductivity, electrical connection is established between the upper electrode layer 44 and the lower electrode layer 43 only through the tunnel-junction magnetoresistive film 45.

A preferential orientation of the (002) surface in the Heusler alloy as described above results in a remarkably enhanced magnetoresistance (MR) ratio of the tunnel-junction magnetoresistive film 45. This leads to an enhanced sensitivity of the read element 42. The read element 42 of this type thus significantly contributes to an improvement in recording density. Moreover, even if the pinning layer 53 made of IrMn is relatively thin, exchange coupling of a sufficient intensity can be obtained. The underlayer 52 made of a nitride has the same thickness as a conventionally used Ru underlayer. Therefore, space can thus be kept relatively small between the lower electrode layer 43 and the upper electrode layer 44. This results in the enhanced linear resolution of magnetic recordation on the magnetic recording disk 14 along the recording track.

Next, a brief description will be made on a method of making the read element 42 and the write element 46. An Al₂O₃—TiC substrate is first prepared. A first Al₂O₃ film is formed on the surface of the Al₂O₃—TiC substrate. The read element 42 and the write element 46 for the individual flying head slider 22 are formed on the first Al₂O₃ film. The write element 46 is formed in a conventional manner. After the fabrication of the read element 42 and the write element 46, a second Al₂O₃ film is formed on the surface of the Al₂O₃—TiC substrate. The first and second Al₂O₃ films form the head protection film 26. The individual flying head slider 22 is cut out of the Al₂O₃—TiC substrate.

The lower electrode layers 43 are formed on the first Al₂O₃ film at predetermined positions. Sputtering is employed to form the lower electrode layers 43, for example. The lower electrode layers 43 are formed in a predetermined shape. Formed in sequence on the lower electrode layer 43 are a film material for the auxiliary underlayer 51, a film material for the underlayer 52, a film material for the pinning layer 53, a film material for the pinned layer 54, a film for the nonmagnetic interlayer 55, a film material for the reference layer 56, a film material for the tunnel barrier layer 57, a film material for the free layer 58, and a film material for the capping layer 59. Specifically, as depicted in FIG. 6, a Ta film 63 of 2.0 nm thickness, a NiFeN film 64 of 3.0 nm thickness, an IrMn film 65 of 7.0 nm thickness, a CoFe film 66 of 1.7 nm thickness, a Ru film 67 of 0.68 nm thickness, a CO₂MnSi film 68 of 2.5 nm thickness, an MgO film 69 having a thickness in a range from 1.0 nm to 1.5 nm, a CoFeB film 71 of 3.0 nm thickness, and a Ta film 72 of 3.0 nm thickness are formed. Sputtering is employed to form the films 63-72, for example. The sputtering is performed in the normal or room temperature. In particular, so-called reactive sputtering is employed to form the NiFeN film 64. In this case, a NiFe target is set in the chamber of a sputtering apparatus. Ar (argon) gas and N₂ (nitrogen) gas are introduced into the chamber. Annealing process is applied to the formed NiFeN film 64 in a magnetic field of 1.5-[T] for duration of two hours. An annealing temperature was set at 350 degrees Celsius, for example. The annealing process proceeded transformation of CO₂MnSi from the A2 structure to the B2 and L2₁ structure. Simultaneously, exchange coupling is induced between the IrMn film 65 and the CoFe film 66.

Photolithography is then applied to shape the tunnel-junction magnetoresistive film 45 out of a layered body of the Ta film 63, the NiFeN film 64, the IrMn film 65, the CoFe film 66, the Ru film 67, the CO₂MnSi film 68, the MgO film 69, the CoFeB film 71 and the Ta film 72. As depicted in FIG. 6, a photoresist film 73 is formed on the capping layer, namely the Ta film 72. Ion milling is then effected. The material in the layered body is removed around the photoresist film 73. The surface of the lower electrode layer 43 is thus exposed around the photoresist film 73.

The insulating film 62 is then formed on the Al₂O₃—TiC substrate in a range from 3.0 nm to 10.0 nm thickness. Here, an Al₂O₃ film is formed, for example. Sputtering is employed to form the insulating film 62. Al₂O₃ is deposited on the photoresist film 73 and the lower electrode layer 43. A film material for the magnetic domain controlling films 61 is then formed on the insulating film 62. Sputtering is employed to form the film material. Here, a CoCrPt film is formed. The tunnel-junction magnetoresistive film 45 is covered with the CoCrPt film. Lift-off process is applied to remove the insulating film 62 and the CoCrPt film from surface of the tunnel-junction magnetoresistive film 45. In other words, the photoresist film 73 is removed from the surface of the tunnel-junction magnetoresistive film 45.

The surface of the CoCrPt film is subjected to polishing and flattening process. Chemical mechanical polishing (CMP) is employed for the polishing and flattening process. The surfaces of the capping layer 59 and the magnetic domain controlling films 61 are leveled to a continuous surface. The upper electrode layer 44 is formed on the continuous surface. Sputtering is employed for the formation, for example. The upper electrode layer 44 is formed in a predetermined shape. The magnetic domain controlling films 61 are subjected to heating process in a magnetic field. The magnetic domain controlling films 61 are magnetized in a predetermined direction. The read element 42 is in this manner produced.

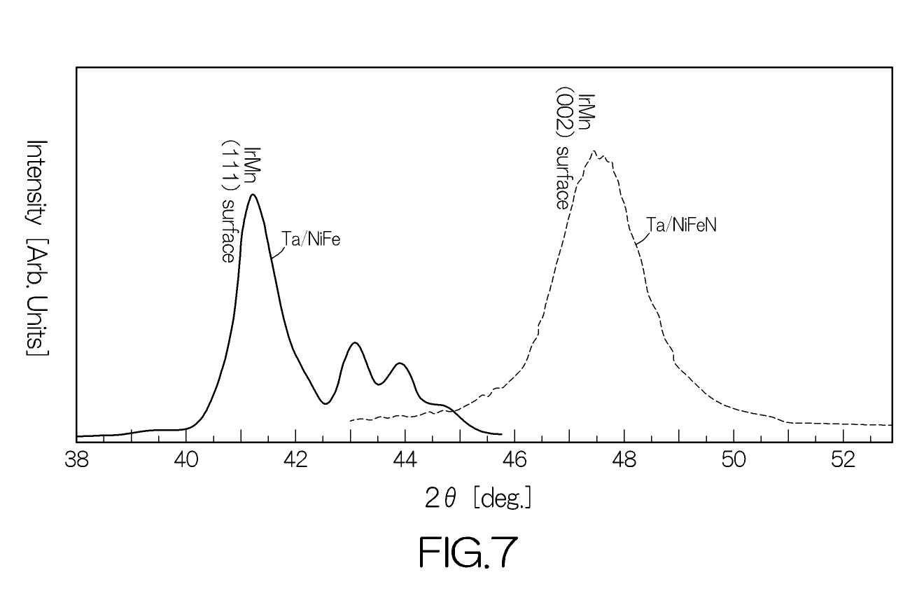

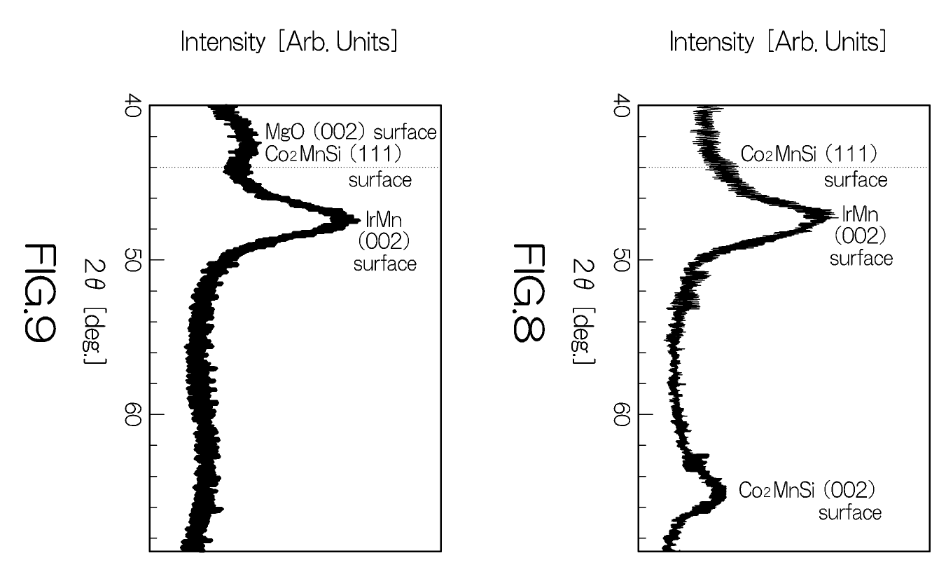

The inventors have examined the relationship between a nitride layer and an antiferromagnetic layer. The inventors formed simple stacked films that is Ta 3/underlayer 3/IrMn 7/CoFe 4 [nm] on a support substrate. The underlayer was made of NiFe and NiFeN. A Si substrate was used as the support substrate. The partial pressure of N₂ gas was set at 73% to form the NiFeN underlayer. The inventors observed the oriented surface of the IrMn pinning layer 53. An X-ray diffractometer using characteristic X rays CuKα rays was employed for the observation. The inventors prepared a comparative example for the observation. The comparative example employed a NiFe underlayer in place of the NiFeN underlayer 52. As depicted in FIG. 7, in the case of the NiFeN underlayer 52, the orientation of the (002) surface was observed in the IrMn pinning layer 53. In the case of the NiFe underlayer, the orientation of the close-packed surface, namely the (111) surface, was observed in the IrMn pinning layer 53. It has been confirmed that the oriented surface relocates in the IrMn pinning layer 53 in response to the addition of nitrogen.

The inventors have also observed the oriented surface of the CO₂MnSi reference layer 56. For the observation, formed in sequence on a glass substrate were a Ta layer of 3.0 nm thickness, a NiFeN layer of 3.0 nm thickness, an IrMn layer of 4.0 nm thickness, a CoFe layer of 1.7 nm thickness, a Ru layer of 0.4 nm thickness, and a CO₂MnSi layer of 10.0 nm thickness, in the same manner as described above. As depicted in FIG. 8, the orientation of the (002) surface was observed in the IrMn layer while the orientation of the (002) surface was observed in the CO₂MnSi layer. The orientation of the (111) surface was not observed in the CO₂MnSi layer. It has been revealed that the (002) surface is oriented in the CO₂MnSi layer when the (002) surface is established in the IrMn layer serving as an underlayer.

The inventors have also observed the oriented surface of the CO₂MnSi reference layer 56. For the observation, formed in sequence on a glass substrate were a Ta layer of 3.0 nm thickness, a NiFeN layer of 3.0 nm thickness, an IrMn layer of 4.0 nm thickness, a CoFe layer of 1.7 nm thickness, a Ru layer of 0.4 nm thickness, a CO₂MnSi layer of 2.0 nm thickness, and a MgO layer of 4.0 nm thickness, in the same manner as described above. As depicted in FIG. 9, the orientation of the (002) surface was observed in the MgO layer. It is easily expected that the orientation of the (002) surface in the MgO layer grows on the (002) layer in the CO₂MnSi layer. Specifically, if the (111) surface is oriented in the CO₂MnSi layer, the (111) surface is inevitably oriented in the MgO layer. The orientation of the (111) surface was not observed in this observation. It was confirmed that the orientation of the (002) surface has been established in the CO₂MnSi layer.

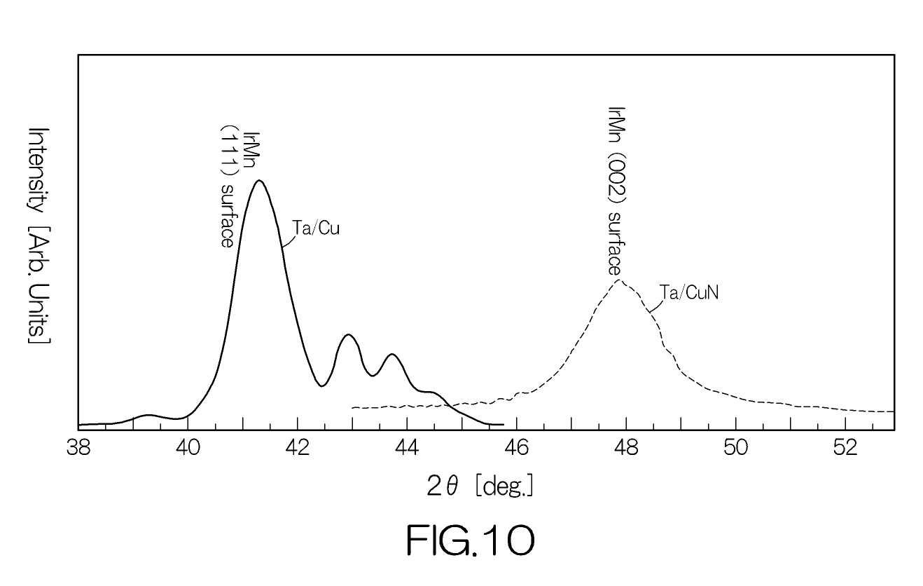

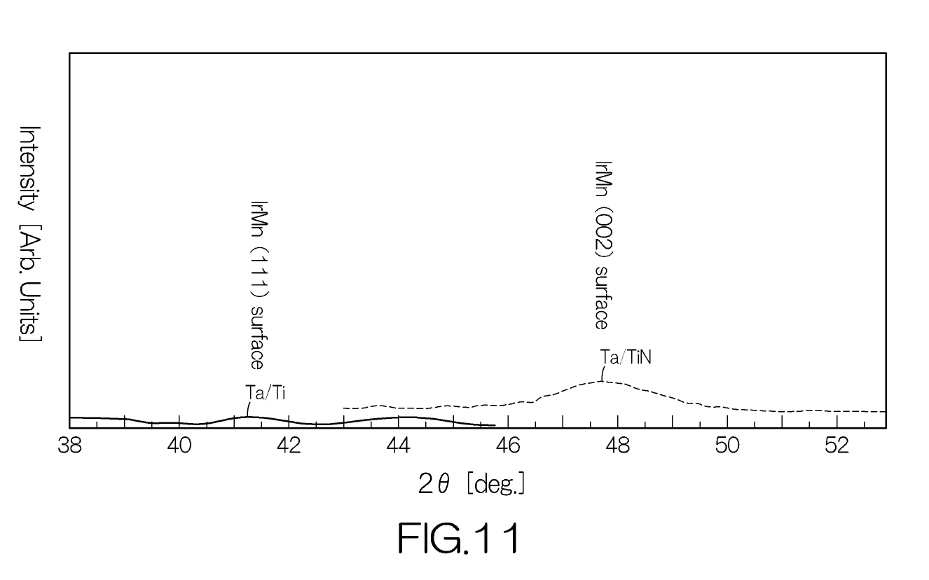

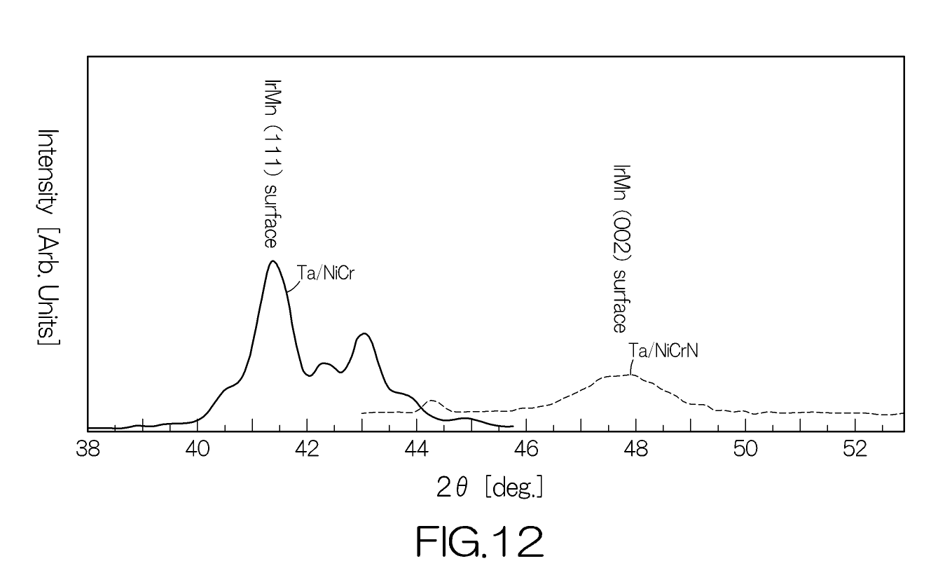

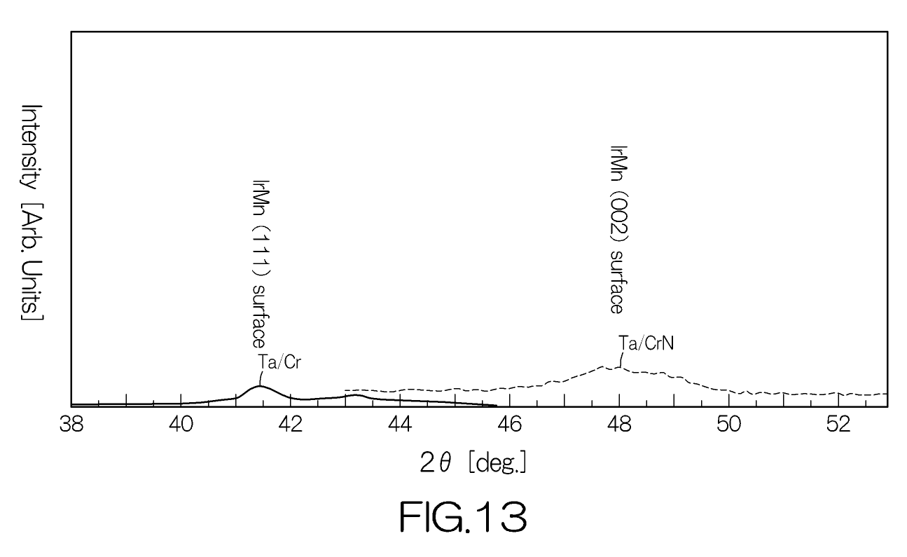

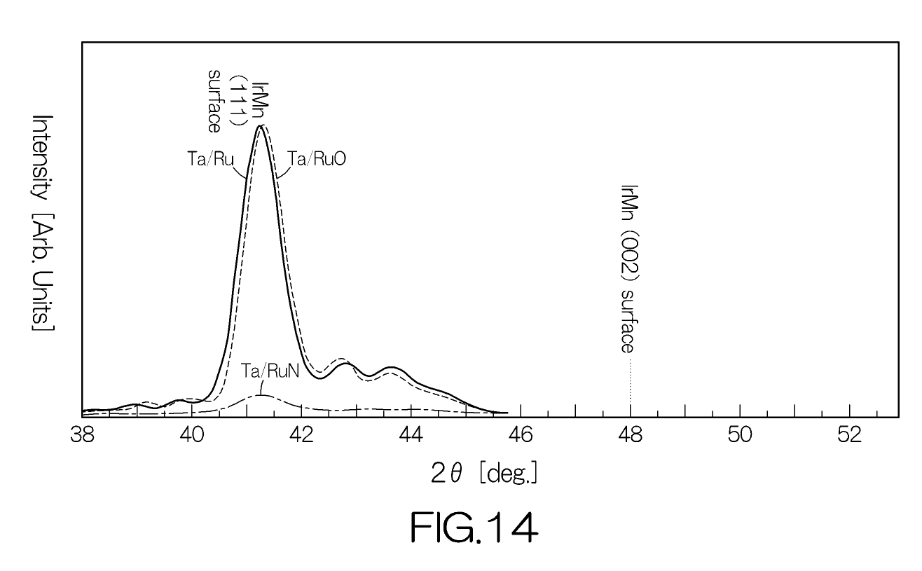

The inventors have also examined the relationships between an antiferromagnetic layer and nitride layers made of various kinds of nitrides. The tunnel-junction magnetoresistive film 45 was formed on the support substrate in the same manner as described above. It should be noted that CuN and Cu layers, TiN and Ti layers, NiCrN and NiCr layers, and CrN and Cr layers are employed as the underlayers in place of the aforementioned NiFeN and NiFe layers, respectively. The partial pressure of N₂ gas was set at 73% to form the nitride layers such as the CuN layer, the TiN layer, the NiCrN layer and the CrN layer. In any case, the addition of nitrogen allows relocation of the oriented surface, as depicted in FIGS. 10-13. Accordingly, the efficiency of these nitrides has been demonstrated. However, the oriented surface fails to relocate in the RuN layer, as depicted in FIG. 14 illustrating the result of observation on Ru and RuN layers.

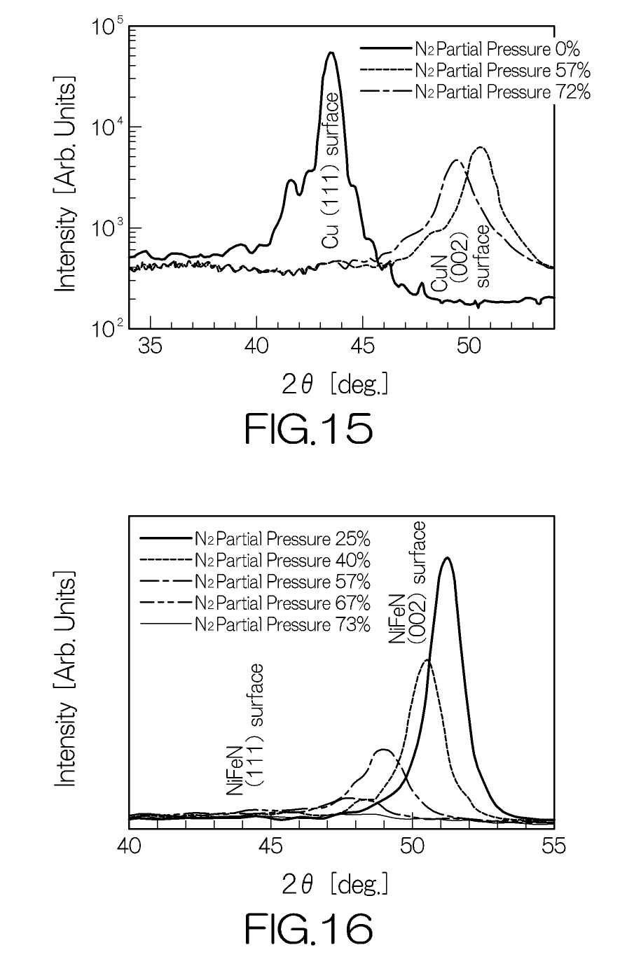

The inventors have also examined the relationship between the partial pressure of nitrogen and the oriented surface of a nitride layer. The inventors formed a Ta layer of 3.0 nm thickness and a CuN layer of 10.0 nm thickness in sequence on a silicon substrate. Sputtering was employed to form the layers. Reactive sputtering was employed to form a nitride layer, namely the CuN layer, in the same manner as described above. The partial pressure was set at three levels such as 0%, 57% and 72%. As depicted in FIG. 15, it has been confirmed that the oriented surface relocates from the (111) surface to the (002) surface in response to the addition of nitrogen. The inventors likewise formed a Ta layer of 3.0 nm and a NiFeN layer of 10.0 nm in sequence on a silicon substrate. Reactive sputtering was employed to form a nitride layer, namely the NiFeN layer in the same manner as described above. The partial pressure was set at five levels such as 25%, 40%, 57%, 67% and 73%. As depicted in FIG. 16, it has been confirmed that an increase in the added nitrogen leads to the gradual disappearance of the orientation of the (002) surface. No correlation has been observed between the orientation of the (002) surface in the IrMn layer and the orientation of the (002) surface in the NiFeN layer.

It should be noted that a CoFe pinned layer of 1.5 nm thickness, a Ru₈₀Rh₂₀ (ruthenium rhodium alloy) nonmagnetic interlayer of 0.5 nm thickness and a Heusler alloy reference layer of 2.5 nm thickness may be employed in place of the aforementioned pinned layer 54, nonmagnetic interlayer 55 and reference layer 56 to establish a laminated ferri structure. In this case, the nonmagnetic interlayer preferably contains Rh in a range from 5 at % to 40 at %. More preferably, the nonmagnetic interlayer contains Rh in a range from 20 at % to 30 at %. The thickness of the nonmagnetic interlayer is preferably set in a range from 0.3 nm to 0.7 nm. More preferably, the thickness of the nonmagnetic interlayer is set in a range from 0.4 nm to 0.7 nm. It should be noted that the nonmagnetic interlayer may be a single Ru layer.

The inventors have also examined the efficiency of CO₂FeAl_{0.5}Si_{0.5} (hereinafter referred to as “CoFeAlSi”) employed in place of the aforementioned CO₂MnSi. Formed in sequence on a glass substrate were a Ta layer of 3.0 nm thickness, a NiFeN layer of 3.0 nm thickness, an IrMn layer of 7.0 nm thickness, and a CoFeAlSi layer of 30.0 nm thickness, in the same manner as described above. A layered body was formed. Sputtering was employed to form each film. The sputtering was performed in the normal or room temperature. After the formation of the films, the layered body was subjected to heating process in a high vacuum oven at 350 degrees Celsius for duration of two hours. The inventors observed the crystalline structure of the layered body with an X-ray diffractometer. As depicted in FIG. 17, the orientation of the (002) surface was observed in the IrMn layer while the orientation of the (001) and (002) surfaces was observed in the CoFeAlSi layer. The orientation of the (001) surface in the CoFeAlSi layer reflects the establishment of the A2 structure. The orientation of the (002) surface in the CoFeAlSi layer reflects the establishment of the B2 structure. The inventors also calculated the volume ratio of the B2 structure based on the integrated intensity 51 of the (001) surface and the integrated intensity 52 of the (002) surface. The calculated volume ratio was approximately 60%. In this case, the integrated intensity 51 of the (001) surface corresponds to the volume of the A2 structure. The integrated intensity 52 of the (002) surface corresponds to the total volume of the A2 structure and the B2 structure.

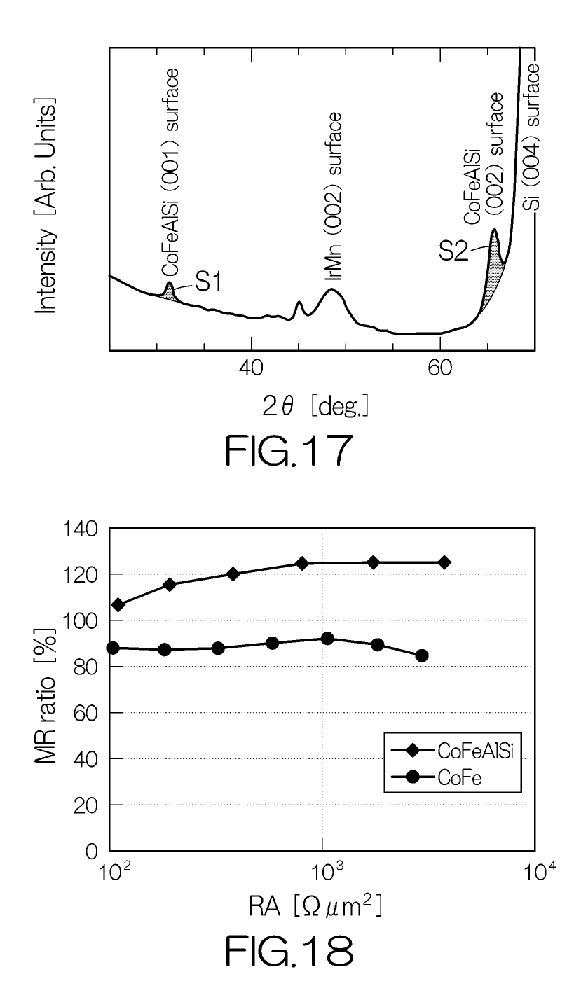

The inventors have also observed the magnetoresistance ratio (MR ratio). For the observation, formed in sequence on a glass substrate were a Ta layer of 3.0 nm thickness, a NiFe layer of 3.0 nm thickness, an IrMn layer of 7.0 nm thickness, a CoFeAlSi layer of 3.0 nm thickness, a MgO layer formed in an inclined film, and CoFeAlSi layer of 3.0 nm thickness, in the same manner as described above. The inclined film had a thickness constantly increasing from one end to the other end of a wafer. The thickness of the inclined film was set at 1.3 nm at the center of the wafer. A tunnel-junction magnetoresistive film according to a specific example was in this manner formed. Sputtering was employed to form each film. The sputtering was performed in the normal or room temperature. A layered body of the films was subjected to heating process in a high vacuum oven at 350 degrees Celsius for duration of two hours. The inventors made a tunnel-junction film according to a comparative example. CoFe layers each having 3.0 nm thickness were employed in the comparative example in place of the CoFeAlSi layers of the specific example, respectively. As is apparent from FIG. 18, it has been confirmed that the tunnel-junction film utilizing the CoFeAlSi layers according to the specific example has a higher MR ratio than the tunnel-junction film utilizing the CoFe layers. It has been demonstrated that the Heusler alloy film of the tunnel-junction film according to the specific example has a polarizability higher than the polarizability of CoFe.

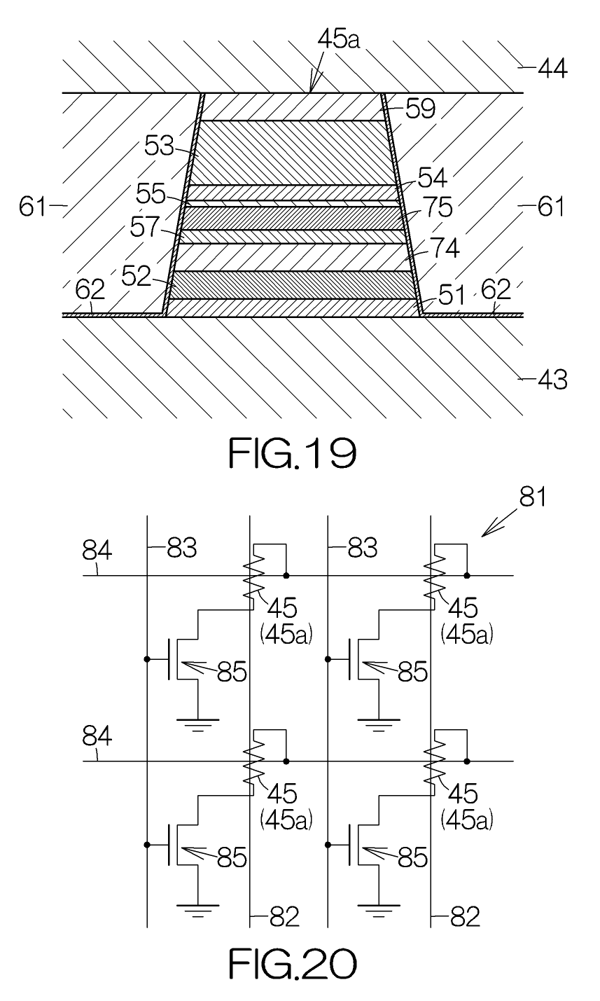

FIG. 19 schematically illustrates a tunnel-junction magnetoresistive film 45a according to a second embodiment. The tunnel-junction magnetoresistive film 45 has a so-called top type layered structure. Specifically, formed in sequence on the lower electrode layer 43 are the auxiliary underlayer 51, the underlayer 52, a free layer 74, the tunnel barrier layer 57, a reference layer 75, the nonmagnetic interlayer 55, the pinned layer 54 and the pinning layer 53 and the capping layer 59. Like reference numerals are attached to the structure or components equivalent to those of the first embodiment. The free layer 74 is made of a Heusler alloy in the tunnel-junction magnetoresistive film 45a. The free layer 74 is made of a CO₂MnSi alloy, for example. The free layer 74 may have a structure identical to the structure of the aforementioned reference layer 56. The reference layer 75 is a ferromagnetic layer. A CoFeB layer is employed as the reference layer 75, for example. The reference layer 75 may have a structure identical to the structure of the aforementioned free layer 58. The tunnel-junction magnetoresistive film 45a realizes the orientation of the (002) surface of the Heusler alloy in the free layer 74 with the assistance of the nitride of the underlayer 52. The magnetoresistance change rate can thus be significantly enhanced.

FIG. 20 schematically illustrates a magnetic random access memory (MRAM) 81. The magnetic random access memory 81 includes write word lines 82 and read work lines 83 alternately extending in parallel with one another in columns. Bit lines 84 in rows intersect the write word lines 82 and the read word lines 83. The aforementioned tunnel-junction magnetoresistive film 45(45a) is connected to the individual bit line 84 at the intersection between the bit line 84 and the write word line 82. The tunnel-junction magnetoresistive film 45(45a) is connected to the source of a MOS transistor 85, for example. The drain of the MOS transistor 85 is grounded. The read word line 83 is connected to the gate of the MOS transistor 85. In the tunnel-junction magnetoresistive film 45(45a), a composite magnetic field of the write word line 82 and the bit line 84 serves to invert the direction of magnetization of the free layer 58(74). The composite magnetic field is generated based on electric currents flowing through the write word line 82 and the bit line 84. The individual tunnel-junction magnetoresistive film 45(45a) can be selected based on the combination of the write word line 82 and the bit word line 84. Binary bit data is in this manner recorded into the tunnel-junction magnetoresistive film 45(45a). Electric current is supplied to the read word line 83 for reading binary bit data. Voltage is applied to the gate of the MOS transistor 85 in response to the supply of the electric current. When the electric current flows through the selected bit line 84, the tunnel-junction magnetoresistive film 45(45a) provides a change in the voltage of the bit line 84. Binary bit data is in this manner detected.

All examples and conditional language recited herein are intended for pedagogical purposes to aid the reader in understanding the invention and the concept contributed by the inventor to furthering the art, and are to be construed as being without limitation to such specifically recited examples and conditions, nor does the organization of such examples in the specification relate to a showing of the superiority and inferiority of the invention. Although the embodiments of the inventions have been described in detail, it should be understood that the various changes, substitutions, and alterations could be made hereto without departing from the spirit and scope of the invention.

What is claimed is:

1. An magnetoresistive element comprising:
an underlayer made of a nitride;
a pinning layer made of an antiferromagnetic layer overlaid on the underlayer, the pinning layer having a close-packed surface in (111) surface of crystal, the pinning layer setting (002) surface of crystal in parallel with a surface of the underlayer;
a reference layer overlaid on the pinning layer, the reference layer having a magnetization fixed in a predetermined direction based on exchange coupling with the pinning layer;
a nonmagnetic layer overlaid on the reference layer, the nonmagnetic layer made of a nonmagnetic material; and
a free layer overlaid on the nonmagnetic layer, the free layer made of a ferromagnetic material, the free layer enabling a change in direction of magnetization under an influence of an external magnetic field.

2. The magnetoresistive element according to claim 1, wherein the antiferromagnetic layer contains Ir and Mn.

3. The magnetoresistive element according to claim 1, wherein the reference layer is made of a Heusler alloy.

4. The magnetoresistive element according to claim 1, wherein the nitride contains one or more element selected from a group consisting of Mg, Ti, Cr, Mn, Fe, Co, Ni, Cu and Mo.

5. The magnetoresistive element according to claim 1, wherein the nonmagnetic material is an insulating material.

6. A layered object comprising:
an underlayer made of a nitride; and
an antiferromagnetic layer overlaid on the underlayer, the antiferromagnetic layer having a close-packed surface in (111) surface of crystal, the antiferromagnetic layer setting (002) surface of crystal in parallel with a surface of the underlayer.

7. The layered object according to claim 6, wherein the antiferromagnetic layer contains Ir and Mn.

8. The layered object according to claim 6, further comprising a Heusler alloy layer overlaid on the antiferromagnetic layer, the Heusler alloy layer having a magnetization fixed in a predetermined direction based on exchange coupling with the antiferromagnetic layer.

9. The layered object according to claim 6, wherein the nitride contains one or more element selected from a group consisting of Mg, Ti, Cr, Mn, Fe, Co, Ni, Cu and Mo
